(19) United States
(12) Patent Application Publication
(10) Pub. No.: US 2024/0292270 A1
(43) Pub. Date: Aug. 29, 2024

(54) TRAFFIC STEERING IN FIXED WIRELESS ACCESS NETWORK

(71) Applicant: T-Mobile USA, Inc., Bellevue, WA (US)

(72) Inventor: Roopesh Kumar Polaganga, Bothell, WA (US)

(21) Appl. No.: 18/174,566

(22) Filed: Feb. 24, 2023

(51) Int. Cl. H04W 28/082; H04L 5/14; H04W 28/08

(52) U.S. Cl. CPC H04W 28/082; H04L 5/1469; H04W 28/0967

(57) ABSTRACT

Systems, methods, and devices that relate to steering of Fixed Wireless Access (FWA) traffic to frequency bands or layers corresponding to the characteristics of the FWA traffic are disclosed. In one example aspect, a method for telecommunication includes determining, by a communication device, a characteristic associated with traffic of a Fixed Wireless Access (FWA) device. The characteristic indicates at least one of a downlink usage pattern, an uplink usage pattern, or a latency requirement associated with the traffic of the FWA device. The method includes determining, by the communication device, a frequency layer allocated for the traffic of the FWA device, selecting, by the communication device, an alternative frequency layer for the traffic of the FWA device based on the characteristic associated with the traffic; and redirecting, by the communication device, the traffic of the FWA device to the alternative frequency layer.

### BACKGROUND

Mobile communication technologies are moving the world toward an increasingly connected and networked society. With the use of advance wireless communication techniques, mobile technology starts to intersect with the demands of fixed line services.

### BRIEF DESCRIPTION OF THE DRAWINGS

Detailed descriptions of implementations of the present technology will be described and explained through the use of the accompanying drawings.

FIG. 1 is a block diagram that illustrates a wireless communications system that can implement aspects of the present technology.

FIG. 2 illustrates an example Fixed Wireless Access (FWA) configuration in accordance with one or more embodiments of the present technology.

FIG. 3 illustrates an example of redirecting FWA traffic in accordance with one or more embodiments of the present technology.

FIG. 4 illustrates an example of different symbol lengths corresponding to different subcarrier spacing values.

FIG. 5 is a flowchart representation of a process or a method for telecommunication in accordance with one or more embodiments of the present technology.

FIG. 6 is a flowchart representation of a process or a method for telecommunication in accordance with one or more embodiments of the present technology.

FIG. 7 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The advent of 5G wireless communication technology allows the mobile technology to intersect with the demands of fixed line services. As compared to wired connections, Fixed Wireless Access (FWA) is an efficient and scalable option to deliver ultra-high-speed broadband to suburban and rural areas. Conventionally, a fixed frequency band or frequency layer is allocated to the FWA traffic from multiple user devices. However, the multiple devices connected to the same FWA device can perform data transmissions that have different characteristics, e.g., downlink streaming, content uploading, video conferencing with simultaneous downlink and uplink usage, and/or latency sensitive gaming. These characteristics make the use of a fixed frequency band insufficient to provide desired experiences for FWA users because the configuration of a fixed frequency band may be suitable for one particular type of transmission, but not for other types of transmissions. For example, a frequency band can be configured to be optimal for downlink transmissions. Such a frequency band cannot provide optimal user experience for heavy traffic in both uplink and downlink directions. As another example, certain frequency bands have smaller bandwidths, leading to longer time-domain delays. Such frequency bands may not be able to meet the requirements of latency sensitive applications.

This document discloses techniques that can be implemented in various embodiments to determine the characteristics of FWA traffic (e.g., either by user indication or network determination, such as using one or more thresholds). For example, users can indicate the application type (e.g., streaming, gaming, etc.) to help determine the characteristics of the network traffic. As another example, the network can track the data packets to determine the characteristics of the ongoing FWA traffic. Once the FWA traffic characteristics are determined, the disclosed techniques can be implemented to steer the FWA traffic to frequency bands or layers configured to accommodate the respective characteristics. Uplink heavy traffic can be steered to frequency bands that are configured to provide optimal uplink transmission experience, and traffic associated with latency-sensitive applications can be steered to higher frequency bands with smaller time-domain delays.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

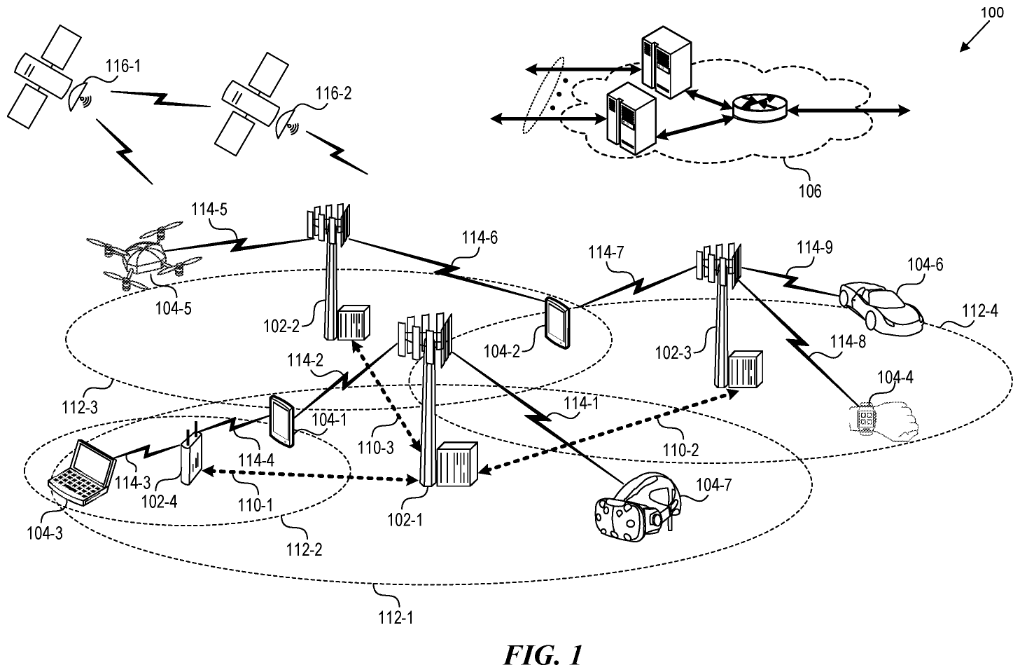

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the wireless telecommunications network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally, or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### Fixed Wireless Access (FWA) Network

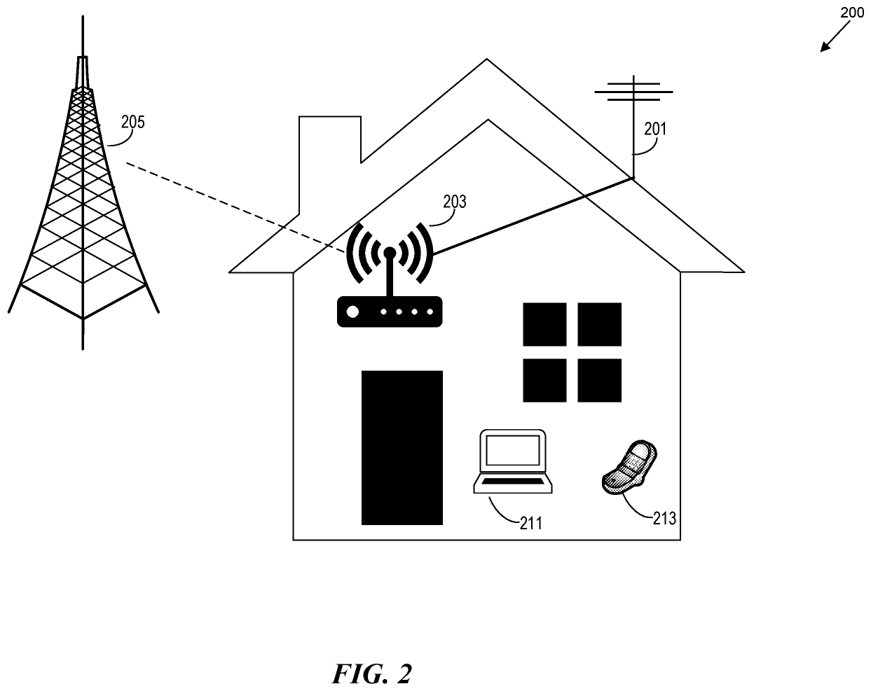

FWA is an efficient and scalable alternative as compared to wired connections, enabling network operators to deliver ultra-high-speed broadband to suburban and rural areas where fiber is prohibitively expensive to lay and maintain. FIG. 2 illustrates an example FWA configuration 200 in accordance with one or more embodiments of the present technology. Customers who registered for FWA services are provided with FWA devices, such as antennas 201 and/or routers 203 that are capable of communicating with the closest base station(s) 205 using cellular access technologies, to obtain ultra-high-speed connections in a location (e.g., residential homes, public parks, community centers, or businesses). User equipment or wireless devices, such as laptops 211 and cell phone 213, are connected to the network via the router 203. The FWA devices (e.g., routers) are expected to have minimal to no mobility because they are deployed as fixed assets in homes or businesses. The use scenarios of the FWA devices differ from conventional user devices in at least the following aspects:
(1) The FWA devices are associated with limited or no mobility events because they are usually deployed at a fixed location within a same location (e.g., co-located).
(2) The FWA devices have no battery constraints, and thus the power control considerations are different from devices such as cell phones or laptops. A higher uplink gain given a high-power class (e.g., power class 1.5 or 2) can translate to a larger coverage footprint for the FWA devices.
(3) Because a FWA device can be connected to several Internet-of-Things (IoT) devices (e.g., smart thermostats, smart alarm systems) that performs data transmissions throughout the day, the FWA device stays mostly connected and rarely goes to the idle mode.
(4) Furthermore, because there are multiple devices connected to a FW device, the average usage from a FWA device is higher as compared to individual user devices such as cell phones and/or tablets.

There remains a need to improve resource allocation and traffic steering for the FWA devices given the different use scenarios as compared to conventional user devices. This patent discloses techniques that can be implemented in various embodiments to enable re-direction of data traffic for the FWA devices based on the traffic characteristics and/or usage patterns provided by users or observed by the network.

Conventionally, traffic of the FWA devices is directed to a fixed frequency band. However, a single FWA device can be connected to multiple devices that perform different types of operations, such as heavy downlink streaming (e.g., a TV with Netflix streaming), heavy uplink streaming (e.g., a personal computer that uploads to YouTube), and/or both downlink and uplink heavy activities (e.g., video conferencing, AR/VR gaming headsets). Having a single fixed frequency band for all types of traffic to/from the FWA device is not sufficient to provide the desired user experiences for FWA users. Considering that operators often have multiple frequency bands deployed in their network with different slot formats to support specific use cases, traffic of the FWA device can be characterized according to the traffic characteristics (e.g., either by user indications and/or network-side determinations) so that different types of traffic can be steered to appropriate frequency bands corresponding to the traffic characteristics.

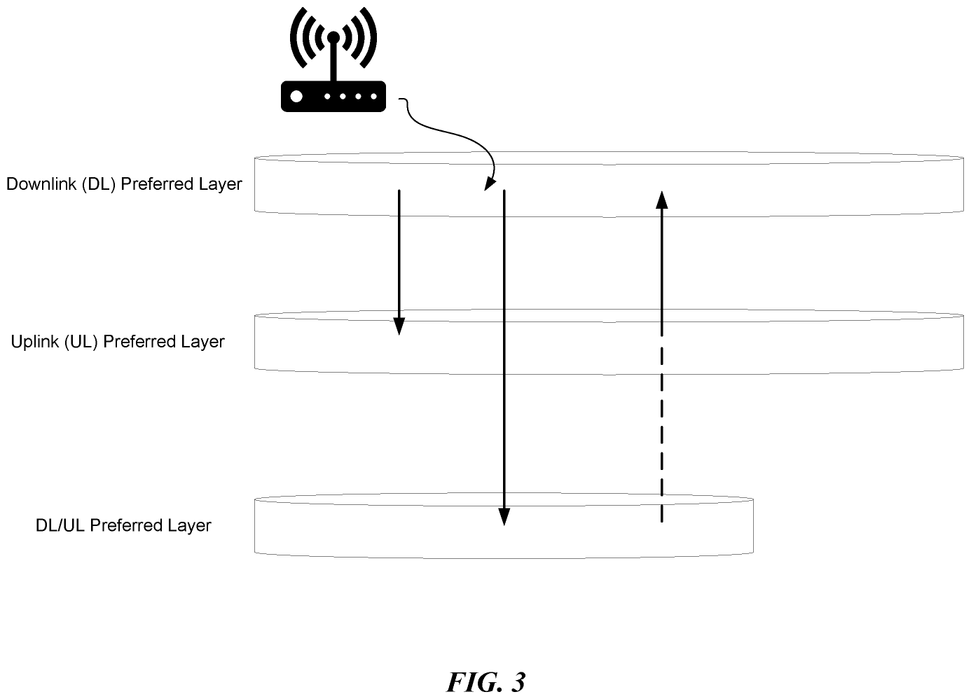

FIG. 3 illustrates an example of redirecting FWA traffic in accordance with one or more embodiments of the present technology. In this example, traffic of the FWA devices in both the downlink and uplink directions is directed to a default frequency band first. In some embodiments, a downlink (DL) preferred band can be used as the default frequency band consistent with other user devices that typically perform more downlink transmissions than uplink transmissions. For example, a sub-band (also referred to as a layer) of the n41 TDD band, commonly referred to as the 2.5 GHz 5G band, can be configured as the default downlink preferred layer. The default downlink preferred layer can be configured such that downlink transmissions have a higher priority than the uplink transmissions. In some implementations, for example, the higher priority of the downlink transmissions can result in 80% of the bandwidth being allocated for downlink transmissions while the remaining 20% of the bandwidth being allocated for uplink transmissions. The bandwidth allocations can change based on the configurations of the base stations.

When the FWA traffic is mostly uplink data (e.g., devices connected to the FWA device upload several large videos to social network platforms), the downlink preferred layer may no longer be suitable for handling such traffic as the 20% bandwidth can quickly be consumed, causing undue delays for the completion of the uplink transmission(s). In those cases, the FWA traffic can be steered or redirected to the uplink preferred layer. For example, another sub-band (or layer) of the n41 TDD band can be configured such that uplink transmissions have a higher priority than the downlink transmissions. In some implementations, the higher priority of the uplink transmissions can result in 80% of the bandwidth being allocated for uplink transmissions while the remaining 20% of the bandwidth being allocated for downlink transmissions.

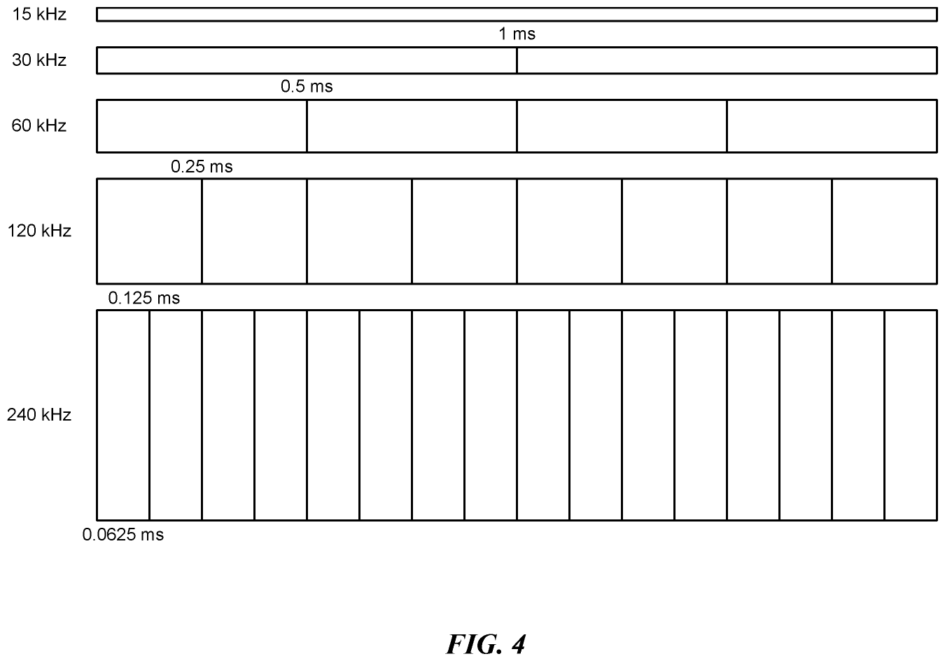

Similarly, when the FWA traffic is both downlink and uplink heavy (e.g., AR/VR games that require constant updating of the location and/or rendering information with low latency requirements), the FWA traffic needs to be redirected to a different layer that is suitable for handling such traffic. For example, the 5G Frequency Range 2 (FR2) includes frequency bands from 24.25 GHz to 52.6 GHz. Bands in this millimeter wave range have shorter range but higher available bandwidths. The higher frequency band(s) can also enable shorter transmission latencies. FIG. 4 illustrates an example of different symbol lengths corresponding to different subcarrier spacing values. As shown in FIG. 4, the time-domain symbol length gets shorter as the communication moves to higher frequency bands with wider subcarrier spacing values (e.g., 120 KHz, 240 kHz). The shorter symbol lengths can enable faster transmission of the data, leading to shorter network latency and better user experience. Larger subcarrier spacing in selected frequency bands are thus desirable for applications that are sensitive to latencies.

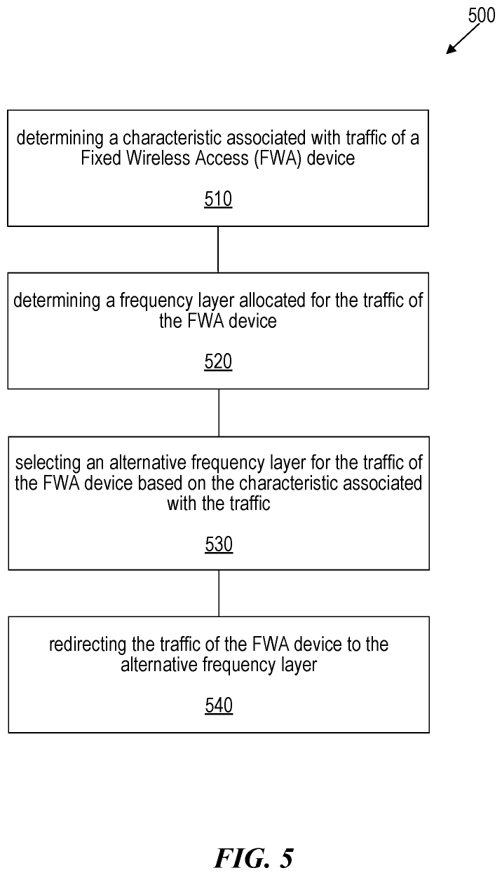

FIG. 5 is a flowchart representation of a method or a process 500 for wireless communication in accordance with one or more embodiments of the present technology. The process 500 includes, at operation 510, determining, by a communication device in a wireless communication network, a characteristic associated with traffic of a Fixed Wireless Access (FWA) device. The FWA device is configured to connect to one or more user devices that are co-located and the traffic of the FWA device represents an aggregation of traffic of the one or more user devices that are co-located. The characteristic indicates at least one of a downlink usage pattern (e.g., traffic from the base station to the FWA device), an uplink usage pattern (e.g., traffic from the FWA device to the base station), or a latency requirement associated with the traffic of the FWA device. The process 500 includes, at operation 520, determining, by the communication device, a frequency layer allocated for the traffic of the FWA device. The frequency layer represents a frequency band or a sub-band of the frequency band. The process 500 includes, at operation 530, selecting, by the communication device, an alternative frequency layer for the traffic of the FWA device based on the characteristic associated with the traffic. The process 500 includes, at operation 540, redirecting, by the communication device, the traffic of the FWA device to the alternative frequency layer.

Several mechanisms can be used to trigger the redirection of the FWA traffic such that FWA users can have the capability to optimize their connectivity to match the use scenarios based on the mix of uplink/downlink data and/or latency requirements. For example, the user can explicitly indicate that the traffic is uplink heavy or DL/UL heavy to trigger a switch from the default layer to another layer. In some embodiments, a user interface can be provided to the user via one of the user devices (e.g., a cell phone) to allow the user to indicate that subsequent traffic has a traffic type that includes at least one of: downlink heavy, uplink heavy, both downlink and uplink heavy, or latency sensitive.

As another example, the network side (e.g., the base station or a network node in the core network) or the FWA can automatically determine the traffic characteristic by tracking the traffic associated with the FWA. In some embodiments, the determining of the characteristic comprises tracking an amount of traffic from the base station to the FWA device for a time duration and characterizing the traffic of the FWA device as downlink heavy upon the amount of downlink traffic exceeding a threshold. For example, the time duration and/or the threshold can be predefined or configured (e.g., periodically). In some embodiments, the determining of the characteristic includes tracking an amount of traffic from the FWA device to the base station for a predetermined time duration and characterizing the uplink traffic of the FWA device as uplink heavy upon the amount of traffic exceeding a threshold. In some embodiments, the determining of the characteristic includes tracking a Quality of Service (QOS) requirement of the traffic of the FWA device for a predetermined time duration and characterizing the traffic of the FWA device as latency sensitive upon the QoS requirement exceeding a threshold. For example, the QoS requirement can be indicated using a 5G QoS indicator (5QI) value or a QoS priority level.

In some embodiments, FWA users can purchase additional data plans to allow them to match their usage with appropriate data plan(s). Extra data buckets can be purchased to increase priority of the traffic (e.g., QoS levels etc.). For example, three types of data plans can be provided for users to use depending on their application use case: (1) uplink heavy mode—X GB of maximum allowed data cap can be provided for uplink usage, (2) downlink Heavy mode—Y GB of maximum allowed data cap can be provided for downlink usage, and (3) low latency mode—Z GB of maximum allowed data cap can be provided for uplink and/or downlink usage.

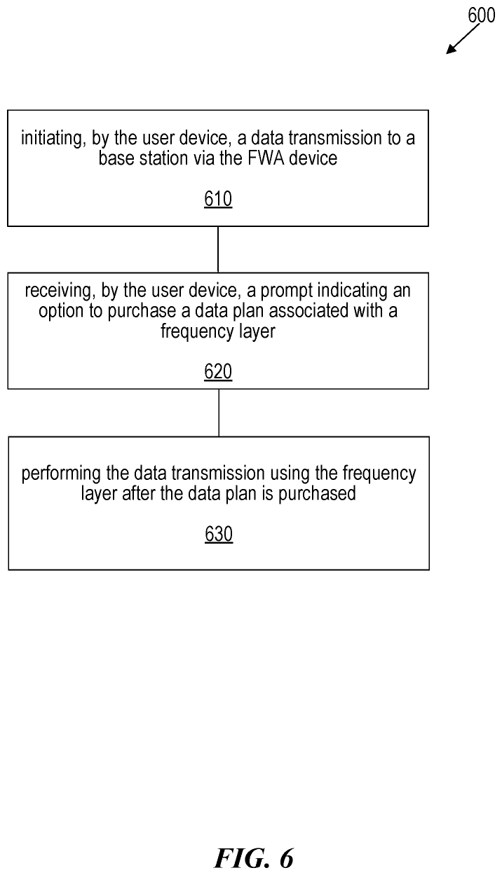

FIG. 6 illustrates an example process or method for wireless communication in accordance with one or more embodiments of the present technology. The process 600 includes, establishing, by a user device, a network connection via a Fixed Wireless Access (FWA) device. The process 600 includes, at operation 610, initiating, by the user device, a data transmission to a base station via the FWA device. The data transmission is associated with a characteristic, the characteristic indicating at least one of a downlink usage pattern, an uplink usage pattern, or a latency requirement associated with the data transmission. The process 600 includes, at operation 620, receiving, by the user device, a prompt indicating an option to purchase a data plan that enable a redirection of the data transmission to a frequency layer that corresponds to the characteristic of the data transmission. In some embodiments, the user can indicate the use of the appropriate data plan prior to initiating the transmission. The process 600 also includes, at operation 630, performing the data transmission using the frequency layer after the data plan is purchased. The frequency layer represents a frequency band or a sub-band of the frequency band. In some embodiments, the frequency layer comprises a first frequency layer configured to prioritize downlink traffic, a second frequency layer configured to prioritize uplink traffic, or a third frequency layer configured with a subcarrier spacing value that shortens a symbol duration. Referring back to FIG. 3, when the purchased data in the data plan or the purchased data buckets are exhausted, the traffic can be steered back to the default frequency layer that is assigned/allocated for FWA traffic.

When traffic steering is triggered either by user indication or network determination, the network can begin to measure data usage against the data caps in the corresponding plans. For example, when “downlink heavy mode” is supported and activated based on user indications/network detection, the frequency layer that is currently assigned/allocated for the traffic is determined first to see if it is already the designated layer to use for downlink heavy traffic (e.g., FR1 TDD layer configured with maximum DL slot format and/or bandwidth). If the current frequency layer is not the designated layer, the designated layer or a target layer that is suitable for downlink heavy traffic is identified. The network then transmits a command to steer or redirect the FWA traffic to the designated/target layer. The command can be an intra-frequency or inter-frequency handover command (e.g., based on the target layer) that is used to steer FWA traffic while the FWA device (e.g., when the FWA device is in the connected mode).

As another example, when “uplink heavy mode” is supported and activated based on user indications/network detection, the frequency layer that is currently assigned/allocated for the traffic is determined first to see if it is already the designated layer to use for uplink heavy traffic (e.g., FR1 TDD layer configured with maximum UL slot format and/or bandwidth). If the current frequency layer is not the designated layer, the designated layer or a target layer that is suitable for uplink heavy traffic is identified. The network then transmits a command to steer or redirect the FWA traffic to the designated/target layer. The command can be an intra-frequency or inter-frequency handover command (e.g., based on the target layer) that is used to steer FWA traffic while the FWA device (e.g., when the FWA device is in the connected mode).

As yet another example, when “low latency mode” is supported and activated based on user indications/network detection, the frequency layer that is currently assigned/allocated for the traffic is determined first to see if it is already the designated layer to use for latency sensitive traffic (e.g., FR2 layer configured with larger subcarrier spacing). If the current frequency layer is not the designated layer, the designated layer or a target layer that is suitable for latency sensitive is identified. The network then transmits a command to steer or redirect the FWA traffic to the designated/target layer. The command can be an intra-frequency or inter-frequency handover command (e.g., based on the target layer) that is used to steer FWA traffic while the FWA device (e.g., when the FWA device is in the connected mode).

In some embodiments, the network side or the FWA device can further distinguish characteristics associated with the traffic of the one or more user devices that are co-located and direct the traffic of the one or more user devices that are co-located to respective frequency layers based on the characteristics. For example, the network side can examine the Access Point Names (APNs) that are associated with data packets from various applications (e.g., Netflix, Xbox). The network side can separate the FWA traffic from different user devices into different flows having different characteristics. For example, different QoS flows having different QoS indicator values can be used. The flow(s) that are determined to be downlink heavy (e.g., the streaming traffic from the TV) can be steered to DL heavy layer(s), the flow(s) that are determined to be both uplink and downlink heavy (e.g., video conference traffic from the laptop) can be steered to DL and UL heavy layer(s), the flow(s) that have low latency requirement (e.g., network gaming traffic) can be steered to latency sensitive layer(s), and flow(s) that have low bandwidth/latency requirement (e.g., traffic from thermostat or smart power plugs) can be steered to lightweight DL/UL layer(s). Additional data plans can be provided to users to enable FWA traffic steering at a device-level granularity.

### Computer System

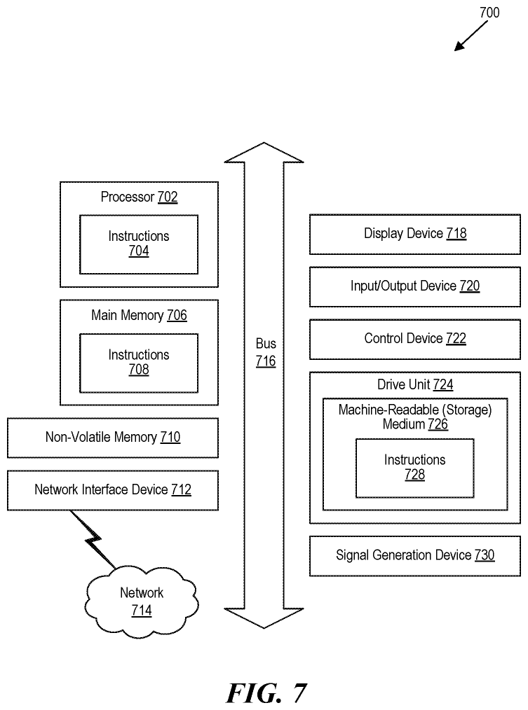

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementation, the computer system 700 can be an embedded computer system, a system-on-chip (SOC), a single-board computer system (SBC) or a distributed system such as a mesh of computer systems or include one or more cloud components in one or more networks. Where appropriate, one or more computer systems 700 can perform operations in real-time, near real-time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### REMARKS

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

What is claimed is:

1. A method for wireless communication, comprising:
determining, by a communication device, a characteristic associated with traffic of a Fixed Wireless Access (FWA) device,
wherein the FWA device is configured to connect to one or more user devices that are co-located and the traffic of the FWA device represents an aggregation of traffic of the one or more user devices,
wherein the characteristic indicates at least one of a downlink usage pattern, an uplink usage pattern, or a latency requirement associated with the traffic of the FWA device, and
wherein the downlink usage pattern indicates an amount of traffic from a base station to the FWA device and the uplink usage pattern indicates an amount of traffic from the FWA device to the base station;
determining, by the communication device, a frequency layer allocated for the traffic of the FWA device,
wherein the frequency layer represents a frequency band or a sub-band of the frequency band via which the FWA device communicates;
selecting, by the communication device, an alternative frequency layer for the traffic of the FWA device based on the characteristic associated with the traffic; and
redirecting, by the communication device, the traffic of the FWA device to the alternative frequency layer.

2. The method of claim 1, wherein the determining of the characteristic comprises:
receiving, by the communication device, an indication from a user of the FWA device indicating the characteristic associated with the traffic.

3. The method of claim 1, wherein the determining of the characteristic comprises:
tracking an amount of traffic from the base station to the FWA device for a time duration; and
characterizing the traffic of the FWA device as downlink heavy upon the amount of traffic exceeding a threshold.

4. The method of claim 1, wherein the determining of the characteristic comprises:
tracking an amount of traffic from the FWA device to the base station for a predetermined time duration;
characterizing the traffic of the FWA device as uplink heavy upon the amount of traffic exceeding a threshold.

5. The method of claim 1, wherein the determining of the characteristic comprises:
tracking a Quality of Service (QOS) requirement of the traffic of the FWA device for a time duration; and
characterizing the traffic of the FWA device as latency sensitive upon the QoS requirement exceeding a threshold.

6. The method of claim 1, wherein the communication device comprises the base station or a network node in a core network of wireless communication.

7. The method of claim 1, wherein the communication device comprises the FWA device.

8. The method of claim 1, wherein the alternative frequency layer comprises a first frequency layer configured to prioritize downlink traffic, a second frequency layer configured to prioritize uplink traffic, or a third frequency layer configured with a subcarrier spacing value that shortens a symbol duration.

9. The method of claim 8, wherein the first frequency layer or the second frequency layer comprises a Time Division Duplexing (TDD) layer in Frequency Range 1 (FR1) of New Radio (NR) access technology, and wherein the third frequency layer comprises a layer in Frequency Range 2 (FR2) of NR access technology.

10. The method of claim 1, further comprising:
distinguishing, by the communication device, characteristics associated with the traffic of the one or more user devices; and
directing, by the communication device, the traffic of the one or more user devices to respective frequency layers based on the characteristics.

11. A device for telecommunication, comprising a processor that is configured to:
determine a characteristic associated with traffic of a Fixed Wireless Access (FWA) device,
wherein the FWA device is configured to connect to one or more user devices and the traffic of the FWA device represents an aggregation of traffic of the one or more user devices,
wherein the characteristic indicates at least one of a downlink usage pattern, an uplink usage pattern, or a latency requirement associated with the traffic of the FWA device,
wherein the downlink usage pattern indicates an amount of traffic from a base station to the FWA device and the uplink usage pattern indicates an amount of traffic from the FWA device to the base station;
determine frequency layer allocated for the traffic of the FWA device,
wherein the frequency layer represents a frequency band or a sub-band of a frequency band;
select an alternative frequency layer for the traffic of the FWA device based on the characteristic associated with the traffic; and
redirect the traffic of the FWA device to the alternative frequency layer.

12. The device of claim 11, wherein the processor is configured to:
receive an indication of a user of the FWA device indicating the characteristic associated with the traffic.

13. The device of claim 11, wherein the processor is configured to:
track an amount of uplink traffic or an amount of downlink traffic for a predetermined time duration;
characterize the traffic of the FWA device as uplink heavy or downlink heavy upon the amount of traffic exceeding a predefined threshold.

14. The device of claim 11, wherein the processor is configured to:
track a Quality of Service (QOS) requirement of the traffic of the FWA device for a predetermined time duration;
characterize the traffic of the FWA device as latency sensitive upon the QoS requirement exceeding a predefined threshold.

15. The device of claim 11, wherein the alternative frequency layer comprises a first frequency layer configured to prioritize downlink traffic, a second frequency layer configured to prioritize uplink traffic, or a third frequency layer configured with a subcarrier spacing value that shortens a symbol duration.

16. The device of claim 15, wherein the first frequency layer or the second frequency layer comprises a Time Division Duplexing (TDD) layer in Frequency Range 1 (FR1) of New Radio (NR) access technology, and wherein the third frequency layer comprises a layer in Frequency Range 2 (FR2) of NR access technology.

17. The device of claim 11, wherein the processor is configured to:
distinguish characteristics associated with the traffic of the one or more user devices; and
direct the traffic of the one or more user devices to respective frequency layers based on the characteristics.

18. A method for wireless communication, comprising:
establishing, by a user device, a network connection via a Fixed Wireless Access (FWA) device,
initiating, by the user device, a data transmission to a base station via the FWA device,
wherein the data transmission is associated with a characteristic, the characteristic indicating at least one of a downlink usage pattern, an uplink usage pattern, or a latency requirement associated with the data transmission;
receiving, by the user device, a prompt indicating an option to purchase a data plan that enable a redirection of the data transmission to a frequency layer that corresponds to the characteristic of the data transmission; and
performing the data transmission using the frequency layer after the data plan is purchased.

19. The method of claim 18, wherein the frequency layer represents a frequency band or a sub-band of the frequency band.

20. The method of claim 18, wherein the frequency layer comprises a first frequency layer configured to prioritize downlink traffic, a second frequency layer configured to prioritize uplink traffic, or a third frequency layer configured with a subcarrier spacing value that shortens a symbol duration.
